(19) United States
(12) Patent Application Publication
(10) Pub. No.: US 2018/0176057 A1
(43) Pub. Date: Jun. 21, 2018

(54) DATA SENDING METHOD AND DEVICE, DATA DEMODULATION METHOD AND DEVICE, AND SYSTEM

(71) Applicant: Huawei Technologies Co., Ltd., Shenzhen (CN)

(72) Inventors: Huang HUANG, Chengdu (CN); Yi WANG, Shanghai (CN); Xiongfei ZOU, Chengdu (CN)

(21) Appl. No.: 15/896,354

(22) Filed: Feb. 14, 2018

Related U.S. Application Data
(63) Continuation of application No. PCT/CN2015/087867, filed on Aug. 21, 2015.

(51) Int. Cl. H04L 27/26; H04L 25/02

(52) U.S. Cl. CPC H04L 27/2607; H04L 5/0007; H04L 27/2666; H04L 25/0202

(57) ABSTRACT

The present invention discloses a data sending method and device, a data demodulation method and device, and a system. The data sending method includes: obtaining, by a sending device, cyclic prefix CP length determining information, where the CP length determining information includes at least one of data stream quantity information of data to be sent by the sending device, type information of the data, information about a distance between the sending device and a receiving device, width information of a beam transmitted by the sending device, type information of the beam, or power information of the beam; determining, by the sending device, a first CP length according to the CP length determining information; and sending, by the sending device, the data to the receiving device, where a CP of the first length is added to the data.

### CROSS-REFERENCE TO RELATED APPLICATIONS

This application is a continuation of International Patent Application No. PCT/CN2015/087867, filed on Aug. 21, 2015, the disclosure of which is hereby incorporated by reference in its entirety.

### TECHNICAL FIELD

The present invention relates to the field of communications technologies, and in particular, to a data sending method and device, a data demodulation method and device, and a system.

### BACKGROUND

OFDM (Orthogonal Frequency Division Multiplexing, orthogonal frequency division multiplexing) is a special frequency multiplexing technology in which multi-carrier modulation is used. A multipath effect is likely to occur during an OFDM propagation process. The multipath effect is explained herein. After an electromagnetic wave is propagated through different paths, all component fields reach a receiving device at different times and are superimposed on each other according to phases of the component fields, and therefore, interference is caused. As a result, an original signal is distorted or an error is caused, leading to signal fading. Therefore, a sending device needs to add a CP (Cyclic Prefix, cyclic prefix) to a beginning of an OFDM symbol. The CP is a duplicate of a part of an end of the OFDM symbol and is placed at the beginning of the OFDM symbol, so as to resist the multipath effect in communication and eliminate symbol interference and interchannel interference.

In an OFDM system, data is sent based on an OFDM symbol. In the OFDM symbol, a CP length needs to be greater than or equal to a multipath delay to resist the multipath effect. As shown in FIG. 1(a), a sending device may send, to a receiving device, a narrow beam whose angle is 3°. A signal propagation path may be classified into a direct path (that is, a path a in the figure) and a reflected path (that is, a path b and a path c in the figure). A time difference of about 8.7 nanoseconds between the direct path and the reflected path can be obtained according to a ratio of a path difference between the direct path and the reflected path to a speed of light or according to a ratio of the sending angle of the narrow beam to a speed of light. That is, sending the narrow beam by the sending device causes a multipath delay of about 8.7 nanoseconds. Therefore, a CP length needs to be greater than or equal to 8.7 nanoseconds to resist the multipath effect. As shown in FIG. 1(b), a sending device may send, to a receiving device, two narrow beams whose angles are 3°. A propagation path of one of the narrow beams is a direct path (that is, a path d whose length is about 50 meters in the figure). A propagation path of the other narrow beam is a reflected path (that is, a path e and a path f in the figure, where a total length of the path e and the path f is about 70 meters). Sending the two narrow beams whose angles are 3° by the sending device causes a multipath delay of about 67 nanoseconds. Therefore, a CP length needs to be greater than or equal to 67 nanoseconds to resist the multipath effect. To satisfy most CP length requirements, in the prior art, two fixed CP lengths (for example, a short CP and a long CP) are stipulated according to a coverage radius of a cell served by a base station. For example, the short CP is always used for a cell with a small radius, and the long CP is always used for a cell with a large radius. However, for different beams sent by a sending device, different multipath delays are caused, and different CP lengths are required. Because the sending device cannot determine a CP length according to an actual situation, but uses a CP of a fixed length, unnecessary system overheads are easily caused. For example, in a cell with a large coverage radius, the sending device can resist the multipath effect by using only a short CP. However, a long CP is always used in the cell with the large coverage radius. In this case, using the long CP increases system overheads. In addition, stipulating use of a CP of a fixed length is also likely to cause a failure of communication between a sending device and a receiving device. For example, in a cell with a small coverage radius, the sending device possibly needs to use a long CP. However, a short CP is always used in the cell with the small coverage radius. Therefore, the sending device can use only the short CP. As a result, the sending device and the receiving device cannot communicate with each other.

### SUMMARY

The present invention provides a data sending method and device, a data demodulation method and device, and a system, so as to dynamically determine a CP length according to CP length determining information, thereby reducing system overheads.

To resolve the foregoing technical issue, a first aspect of the present invention provides a data sending method, including:

obtaining, by a sending device, cyclic prefix CP length determining information, where the CP length determining information includes at least one of data stream quantity information of data to be sent by the sending device, type information of the data, information about a distance between the sending device and a receiving device, width information of a beam transmitted by the sending device, type information of the beam, or power information of the beam;

determining, by the sending device, a first CP length according to the CP length determining information; and

sending, by the sending device, the data to the receiving device, where a CP of the first length is added to the data.

With reference to the first aspect, in a first possible implementation of the first aspect, if the CP length determining information includes any one of the data stream quantity information of the data to be sent by the sending device, the type information of the data, the information about the distance between the sending device and the receiving device, the width information of the beam transmitted by the sending device, the type information of the beam, or the power information of the beam, the determining, by the sending device, a first CP length according to the CP length determining information includes:

searching, by the sending device, for the corresponding first CP length according to the any one of the data stream quantity information of the data to be sent by the sending device, the type information of the data, the information about the distance between the sending device and the receiving device, the width information of the beam transmitted by the sending device, the type information of the beam, or the power information of the beam.

With reference to the first aspect, in a second possible implementation of the first aspect, if the CP length determining information includes at least two of the data stream quantity information of the data to be sent by the sending device, the type information of the data, the information about the distance between the sending device and the receiving device, the width information of the beam transmitted by the sending device, the type information of the beam, or the power information of the beam, the determining, by the sending device, a first CP length according to the CP length determining information includes:

searching, by the sending device, for a corresponding CP length according to the at least two of the data stream quantity information of the data to be sent by the sending device, the type information of the data, the information about the distance between the sending device and the receiving device, the width information of the beam transmitted by the sending device, the type information of the beam, or the power information of the beam; and

determining, by the sending device, the first CP length according to the corresponding CP length that is found.

A second aspect of the present invention provides a data demodulation method, including:

obtaining, by a receiving device, cyclic prefix CP length determining information, where the CP length determining information includes at least one of data stream quantity information of data sent by a sending device, type information of the data, information about a distance between the sending device and the receiving device, width information of a beam transmitted by the sending device, type information of the beam, or power information of the beam;

determining, by the receiving device, a first CP length according to the CP length determining information;

receiving, by the receiving device, the data sent by the sending device, where a CP of the first length is added to the data; and

demodulating, by the receiving device, the data according to the first CP length.

A third aspect of the present invention provides a data sending device, including:

an obtaining module, configured to obtain cyclic prefix CP length determining information, where the CP length determining information includes at least one of data stream quantity information of data to be sent by the device, type information of the data, information about a distance between the device and a receiving device, width information of a beam transmitted by the device, type information of the beam, or power information of the beam;

a determining module, configured to determine a first CP length according to the CP length determining information obtained by the obtaining module; and

a sending module, configured to send the data to the receiving device, where a CP of the first length determined by the determining module is added to the data.

With reference to the third aspect, in a first possible implementation of the third aspect, if the CP length determining information includes any one of the data stream quantity information of the data to be sent by the device, the type information of the data, the information about the distance between the device and the receiving device, the width information of the beam transmitted by the device, the type information of the beam, or the power information of the beam, the determining module is specifically configured to:

search for the corresponding first CP length according to the any one of the data stream quantity information of the data to be sent by the device, the type information of the data, the information about the distance between the device and the receiving device, the width information of the beam transmitted by the device, the type information of the beam, or the power information of the beam.

With reference to the third aspect, in a second possible implementation of the third aspect, if the CP length determining information includes at least two of the data stream quantity information of the data to be sent by the device, the type information of the data, the information about the distance between the device and the receiving device, the width information of the beam transmitted by the device, the type information of the beam, or the power information of the beam, the determining module is specifically configured to:

search for a corresponding CP length according to the at least two of the data stream quantity information of the data to be sent by the device, the type information of the data, the information about the distance between the device and the receiving device, the width information of the beam transmitted by the device, the type information of the beam, or the power information of the beam; and

determine the first CP length according to the corresponding CP length that is found.

A fourth aspect of the present invention provides a data demodulation device, including:

an obtaining module, configured to obtain cyclic prefix CP length determining information, where the CP length determining information includes at least one of data stream quantity information of data sent by a sending device, type information of the data, information about a distance between the sending device and the device, width information of a beam transmitted by the sending device, type information of the beam, or power information of the beam;

a determining module, configured to determine a first CP length according to the CP length determining information obtained by the obtaining module;

a receiving module, configured to receive the data sent by the sending device, where a CP of the first length determined by the determining module is added to the data; and

a demodulation module, configured to demodulate the data according to the first CP length.

A fifth aspect of the present invention provides a system, including a sending device and a receiving device, where

the sending device is configured to: obtain cyclic prefix CP length determining information, where the CP length determining information includes at least one of data stream quantity information of data to be sent by the sending device, type information of the data, information about a distance between the sending device and the receiving device, width information of a beam transmitted by the sending device, type information of the beam, or power information of the beam; determine a first CP length according to the CP length determining information; and send the data to the receiving device, where a CP of the first length is added to the data; and

the receiving device is configured to: obtain the CP length determining information; determine the first CP length according to the CP length determining information; receive the data sent by the sending device, where the CP of the first length is added to the data; and demodulate the data according to the first CP length.

According to the present invention, the sending device obtains the cyclic prefix CP length determining information, where the CP length determining information includes at least one of the data stream quantity information of the data to be sent by the sending device, the type information of the data, the information about the distance between the sending device and the receiving device, the width information of the beam transmitted by the sending device, the type information of the beam, or the power information of the beam. The sending device determines the first CP length according to the CP length determining information. The sending device sends the data to the receiving device, where the CP of the first length is added to the data. The sending device may dynamically determine the CP length according to the CP length determining information before sending the data. This can reduce system overheads, protect system performance, and ensure that the sending device and the receiving device communicate normally.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic diagram of an existing method for calculating a multipath delay;

FIG. 2 is a schematic structural diagram of data;

FIG. 3 is a schematic flowchart of an embodiment of a data sending method according to the embodiments of the present invention;

FIG. 4 is a schematic flowchart of another embodiment of a data sending method according to the embodiments of the present invention;

FIG. 5 is a schematic diagram of sending, by a sending device, a data stream to a receiving device according to another embodiment of a data sending method in the embodiments of the present invention;

FIG. 6 is a schematic diagram of simultaneously sending, by a sending device, a data stream to at least two receiving devices according to another embodiment of a data sending method in the embodiments of the present invention;

FIG. 7 is a schematic flowchart of another embodiment of a data sending method according to the embodiments of the present invention;

FIG. 8 is a schematic structural diagram of a frame in high-frequency cellular communication according to another embodiment of a data sending method in the embodiments of the present invention;

FIG. 9 is a schematic diagram of width of a beam transmitted by a sending device according to another embodiment of a data sending method in the embodiments of the present invention;

FIG. 10 is a schematic flowchart of another embodiment of a data sending method according to the embodiments of the present invention;

FIG. 11 is a schematic diagram of a type of a beam transmitted by a sending device according to another embodiment of a data sending method in the embodiments of the present invention;

FIG. 12 is a schematic flowchart of another embodiment of a data sending method according to the embodiments of the present invention;

FIG. 13 is a schematic flowchart of another embodiment of a data sending method according to the embodiments of the present invention;

FIG. 14 is a schematic structural diagram of a data frame in a local area network communications system according to another embodiment of a data sending method in the embodiments of the present invention;

FIG. 15 is a schematic flowchart of another embodiment of a data sending method according to the embodiments of the present invention;

FIG. 16 is a schematic diagram of a distance between a sending device and a receiving device according to another embodiment of a data sending method in the embodiments of the present invention;

FIG. 17 is a schematic flowchart of an embodiment of a data demodulation method according to the embodiments of the present invention;

FIG. 18 is a schematic structural diagram of an embodiment of a data sending device according to the embodiments of the present invention;

FIG. 19 is a schematic structural diagram of another embodiment of a data sending device according to the embodiments of the present invention;

FIG. 20 is a schematic structural diagram of an embodiment of a data demodulation device according to the embodiments of the present invention;

FIG. 21 is a schematic structural diagram of another embodiment of a data demodulation device according to the embodiments of the present invention;

FIG. 22 is a schematic structural diagram of an embodiment of a system according to the embodiments of the present invention; and

FIG. 23 is a schematic structural diagram of another embodiment of a system according to the embodiments of the present invention.

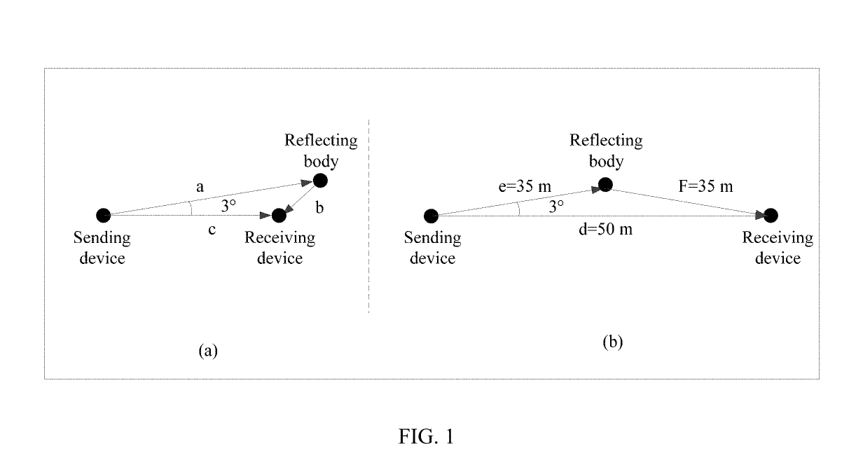

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

The embodiments of the present invention provide a data sending method and device, a data demodulation method and device, and a system, so as to dynamically determine a CP length according to CP length determining information, thereby reducing system overheads.

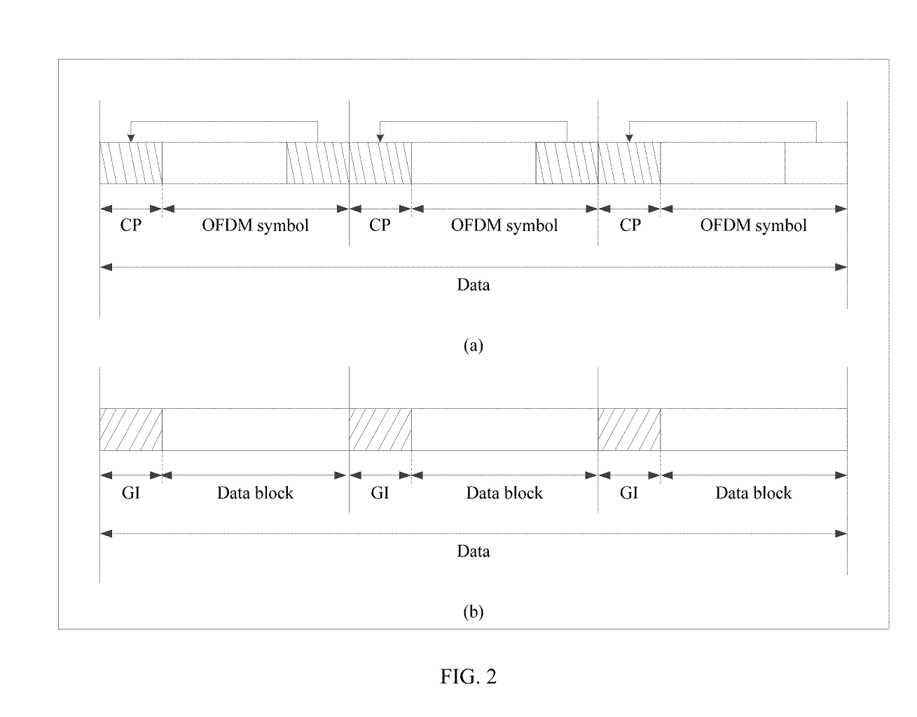

During a propagation process of data related to the embodiments of the present invention, to eliminate symbol interference and interchannel interference, a CP or a GI (Guard Interval, guard interval) may be added, to resist a multipath effect. For example, as shown in FIG. 2(a), in an OFDM system, data is transmitted by using an OFDM symbol as a unit. Therefore, a part of an end of the OFDM symbol is duplicated and placed at a beginning of the OFDM symbol. The part placed at the beginning of the OFDM symbol is a CP. Before sending data, a sending device adds a CP to a beginning of the data. After receiving the data sent by the sending device, a receiving device removes the CP to finally obtain original data. The CP is redundant data. When a CP length is greater than or equal to a multipath delay, a multipath effect in a subchannel can be resisted. For another example, a GI may be applied to a local area network communications system. During data sending, data may be divided into different data blocks for sending. Therefore, as shown in FIG. 2(b), to ensure data transmission reliability, data information that has a preset length and that is known by a receiving device is used as a GI, and the GI is added to a beginning of each data block, so as to ensure that the receiving device can correctly parse each data block, thereby resisting a multipath effect. Therefore, the embodiments of the present invention are also applicable to GI length determining. For GI length determining, refer to an embodiment of CP length determining, and details are not described in the embodiments.

The embodiments of the present invention may not only be applied to a high-frequency cellular communications system but also be applied to a local area network communications system. As a data volume required by users increases, currently, bandwidth of a frequency band lower than a frequency band of 6 GHz is insufficient to meet an increasing communication requirement. Therefore, using a high frequency (greater than or equal to 30 G) gradually becomes a tendency of information transmission. In the high-frequency cellular communications system, a cellular radio networking manner is used in a high frequency band, and a terminal and a network device are connected by using a wireless channel, so as to implement mobile communication. The local area network communications system may include an Ethernet, a WiFi (Wireless Fidelity, Wireless Fidelity) local area network, or the like.

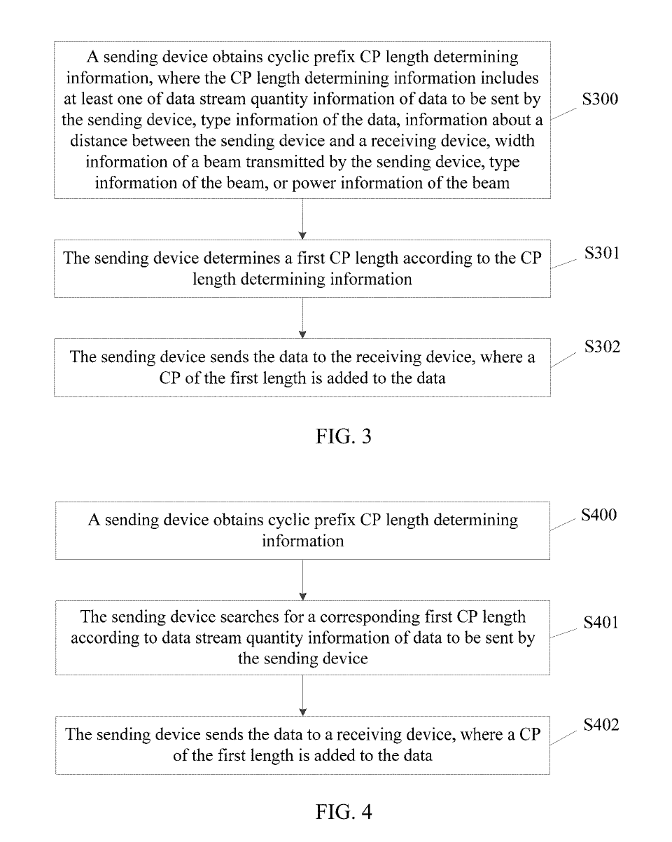

Referring to FIG. 3, FIG. 3 is a schematic flowchart of an embodiment of a data sending method according to the embodiments of the present invention. A sending device in this embodiment of the present invention may be either a network device or a terminal device, and a receiving device in this embodiment of the present invention may also be either a network device or a terminal device. The network device may be, for example, a base station, an MME (Mobility Management Entity, mobility management entity), an S-GW (Serving Gateway, serving gateway), a P-GW (Packet Data Network Gateway, PDN gateway), or another network device. The terminal device may be a mobile phone, a tablet computer, a notebook computer, a palmtop computer, a mobile Internet device (MID, mobile interne device), or another device that can support network interaction.

As shown in FIG. 3, this embodiment of the data sending method according to the embodiments of the present invention may include the following steps.

S300: The sending device obtains cyclic prefix CP length determining information, where the CP length determining information includes at least one of data stream quantity information of data to be sent by the sending device, type information of the data, information about a distance between the sending device and the receiving device, width information of a beam transmitted by the sending device, type information of the beam, or power information of the beam.

In specific implementation, the sending device may obtain CP length determining information each time before sending data, to calculate a first CP length according to the determining information. The CP length determining information includes at least one of the data stream quantity information of the data to be sent by the sending device, the width information of the beam, the type information of the beam, the power information of the beam, the type information of the data, or the information about the distance between the sending device and the receiving device. The sending device can extract, from the sending device itself, the data stream quantity information of the data, the width information of the beam, the type information of the beam, the power information of the beam, and the type information of the data. Therefore, the sending device does not need to obtain the foregoing information from another device (for example, the receiving device). The sending device may directly perform measurement or obtain, from the receiving device, location information of the receiving device, to determine the information about the distance between the sending device and the receiving device.

S301: The sending device determines a first CP length according to the CP length determining information.

In specific implementation, the sending device may preset a correspondence between CP length determining information and a CP length, and then search for the first CP length according to the foregoing obtained CP length determining information, to generate a CP according to the determined first length.

S302: The sending device sends the data to the receiving device, where a CP of the first length is added to the data.

In specific implementation, the sending device may add the CP of the first length to a beginning of the data, so as to resist a multipath effect and reduce system overheads during a data transmission process.

According to this embodiment of the present invention, the sending device obtains the cyclic prefix CP length determining information, where the CP length determining information includes at least one of the data stream quantity information of the data to be sent by the sending device, the type information of the data, the information about the distance between the sending device and the receiving device, the width information of the beam transmitted by the sending device, the type information of the beam, or the power information of the beam. The sending device determines the first CP length according to the CP length determining information. The sending device sends the data to the receiving device, where the CP of the first length is added to the data. The sending device may dynamically determine a CP length according to CP length determining information each time before sending data. This can reduce system overheads, protect system performance, and ensure that the sending device and the receiving device communicate normally.

Referring to FIG. 4, FIG. 4 is a schematic flowchart of another embodiment of a data sending method according to the embodiments of the present invention. In this embodiment of the present invention, all implementations of CP length determining information are enumerated by using examples. A type and quantity of information included in the CP length determining information are not limited in this embodiment. In the following example in this embodiment of the present invention, the CP length determining information includes data stream quantity information of data to be sent by a sending device.

As shown in FIG. 4, the another embodiment of the data sending method according to the embodiments of the present invention may include the following steps.

S400: The sending device obtains the cyclic prefix CP length determining information.

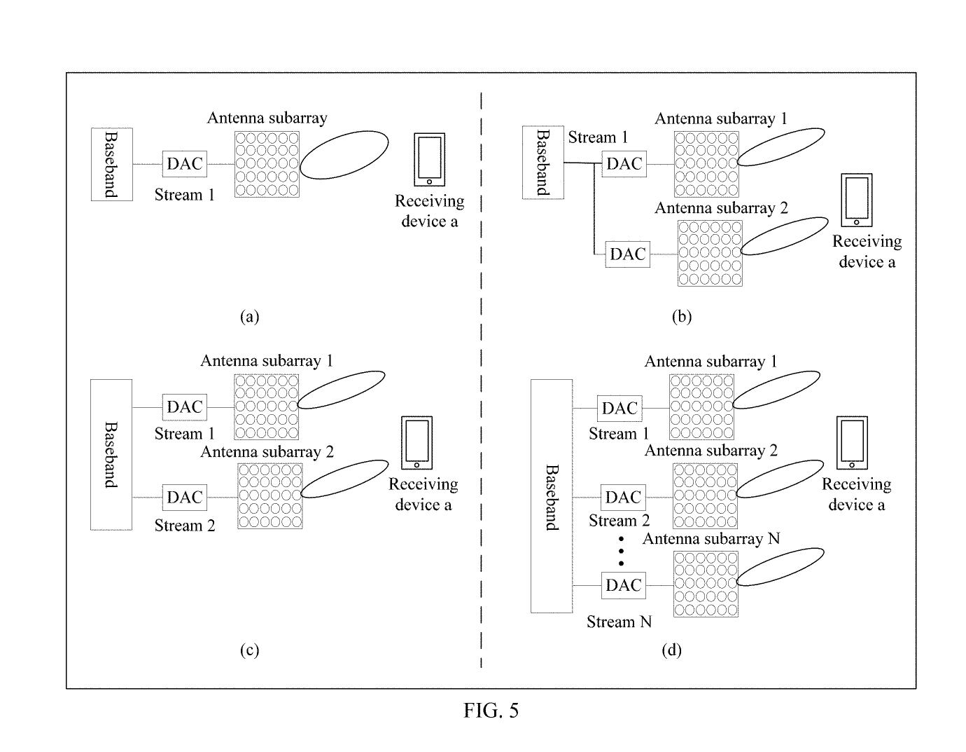

In specific implementation, the CP length determining information obtained by the sending device may include the data stream quantity information of the data to be sent by the sending device. Each time before sending data to a receiving device, the sending device needs to determine a quantity of data streams to be sent to at least one receiving device. As shown in FIG. 5, FIG. 5 is a schematic diagram of sending, by the sending device, a data stream to one receiving device. For example, the receiving device is a receiving device a. The sending device may transmit data to the receiving device a from a baseband by using one data stream, as shown in FIG. 5(a) or FIG. 5(b) (the sending device in FIG. 5(b) splits one data stream for transmission by using two digital-to-analog converters (DAC, Digital to Analog Converter)). Alternatively, the sending device may transmit data to the receiving device a from a baseband by using two data streams or N data streams, as shown in FIG. 5(c) or FIG. 5(d). Therefore, for FIG. 5(a) or FIG. 5(b), the data stream quantity information included in the CP length determining information is 1; for FIG. 5(c), the data stream quantity information included in the CP length determining information is 2; for FIG. 5(d), the data stream quantity information included in the CP length determining information is N.

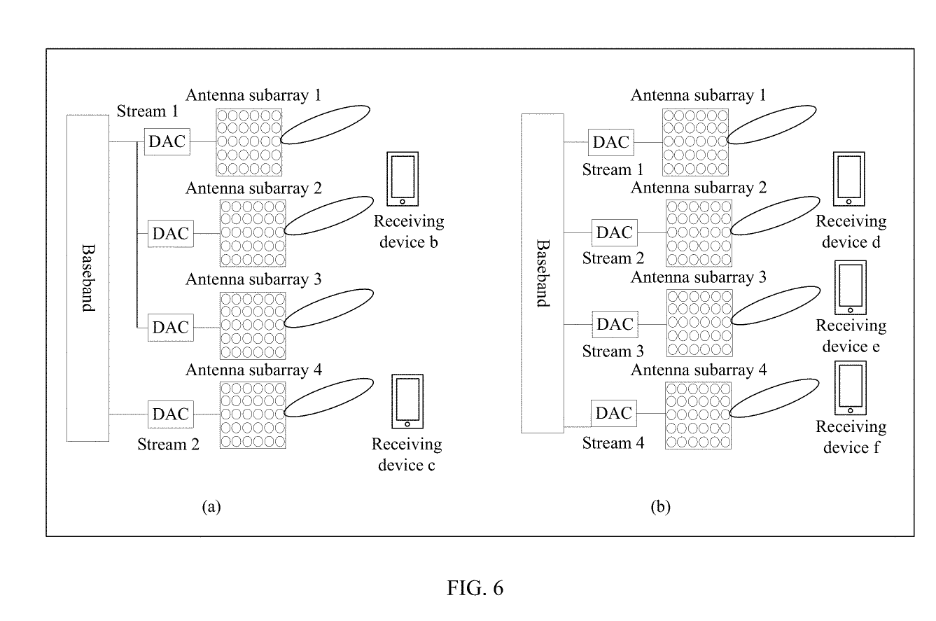

In an implementation, as shown in FIG. 6, FIG. 6 is a schematic diagram of simultaneously sending, by the sending device, a data stream to at least two receiving devices. The sending device may simultaneously serve the at least two receiving devices. As shown in FIG. 6(a), the sending device simultaneously serves a receiving device b and a receiving device c. The sending device transmits one data stream to the receiving device b (the sending device splits the one data stream for transmission by using three DACs), and transmits one data stream to the receiving device c. Therefore, the sending device transmits a total of two data streams. Therefore, for FIG. 6(a), the data stream quantity information included in the CP length determining information is 2. As shown in FIG. 6(b), the sending device simultaneously serves a receiving device d, a receiving device e, and a receiving device f. The sending device transmits two data streams to the receiving device d, and transmits one data stream to each of the receiving device e and the receiving device f. Therefore, the sending device transmits a total of four data streams. Therefore, for FIG. 6(b), the data stream quantity information included in the CP length determining information is 4.

S401: The sending device searches for a corresponding first CP length according to the data stream quantity information of the data to be sent by the sending device.

In specific implementation, a quantity of data streams to be sent by the sending device determines a CP length. Therefore, the sending device may determine the CP length according to the specific quantity of data streams that are to be transmitted to at least one receiving device. In addition, the CP length is directly proportional to the quantity of to-be-sent data streams. That is, a larger quantity of data streams to be sent by the sending device indicates a larger CP length. Therefore, a correspondence between a quantity of data streams and a CP length may be preset. The sending device may obtain a required CP length according to data stream quantity information of to-be-sent data and a correspondingly generated multipath delay, to establish a correspondence between the data stream quantity information and the CP length.

In an implementation, if the sending device has multiple optional CP lengths to select from, the sending device may search for the corresponding first CP length according to the data stream quantity information of the to-be-sent data and a supported quantity of CP length types. For example, Table 1 is a correspondence table of a CP length used when the sending device sends a data stream to one receiving device, and includes a correspondence between a quantity of data streams and a CP length. In the table, N represents a quantity of to-be-sent data streams that is supported by the sending device, and M represents a quantity of CP length types that is supported by the sending device. For example, if the quantity of to-be-sent data streams that is supported by the sending device is 5, and the supported quantity of CP length types is 6 (that is, a corresponding matching mode is a matching mode 1, N=5, and M=6), when the sending device sends, as shown in FIG. 5(a) or FIG. 5(b), one data stream to the receiving device a, a corresponding first CP length is a length identified by CP1 in Table 1. If the quantity of to-be-sent data streams that is supported by the sending device is 5, and the supported quantity of CP length types is 3 (that is, a corresponding matching mode is a matching mode 2, N=5, and M=3), when the sending device sends, as shown in FIG. 5(c), two data streams to the receiving device a, the sending device determines that a corresponding first CP length is a length identified by CP2 in Table 1. The rest may be deduced by analogy.

TABLE 1

| Matching mode 1 | | Matching mode 2 | | Matching mode 3 | |
|---|---|---|---|---|---|
| (N = 5, M = 6) | | (N = 5, M = 3) | | (N = 5, M = 5) | |
| Quantity of | | Quantity of | | Quantity of | |
| to-be-sent | | to-be-sent | | to-be-sent | |
| data | | data | | data | |
| streams | CP length | streams | CP length | streams | CP length |
| 1 | CP 1 | 1 | CP 1 | 1 | CP1 |
| 2 | CP 1 | 2 | CP2 | 2 | CP2 |
| 3 | CP3 | 3 | CP2 | 3 | CP3 |
| 4 | CP4 | 4 | CP3 | 4 | CP4 |
| 5 | CP6 | 5 | CP3 | 5 | CP5 |

In an implementation, in a case shown in FIG. 6, that is, when the sending device simultaneously serves at least two receiving devices, the quantity information of data streams to be sent by the sending device in FIG. 6(a) is 2, and the quantity information of data streams to be sent by the sending device in FIG. 6(b) is 4. A quantity of data streams to be sent by the sending device in FIG. 6(a) is less than a quantity of data streams to be sent by the sending device in FIG. 6(b). Therefore, a first CP length determined by the sending device in FIG. 6(a) is less than a first CP length determined by the sending device FIG. 6(b). In FIG. 6(a), first CP lengths of data to be sent by the sending device to the receiving device b and the receiving device c are both searched for according to the data stream quantity information that is 2. In FIG. 6(b), first CP lengths of data to be sent by the sending device to the receiving device d, the receiving device e, and the receiving device f are all searched for according to the data stream quantity information that is 4.

Optionally, the sending device shown in FIG. 6 may alternatively determine a first CP length by referring to Table 1.

S402: The sending device sends the data to the receiving device, where a CP of the first length is added to the data.

In specific implementation, after finding the first CP length according to the data stream quantity information of the to-be-sent data, the sending device may add the CP of the first length to a beginning of the data, so as to resist a multipath effect and reduce system overheads during a data transmission process.

According to this embodiment of the present invention, the sending device obtains the cyclic prefix CP length determining information, where the CP length determining information includes the data stream quantity information of the data to be sent by the sending device. The sending device determines the first CP length according to the data stream quantity information of the to-be-sent data. The sending device sends the data to the receiving device, where the CP of the first length is added to the data. The sending device may dynamically determine a CP length according to CP length determining information each time before sending data. This can reduce system overheads, protect system performance, and ensure that the sending device and the receiving device communicate normally.

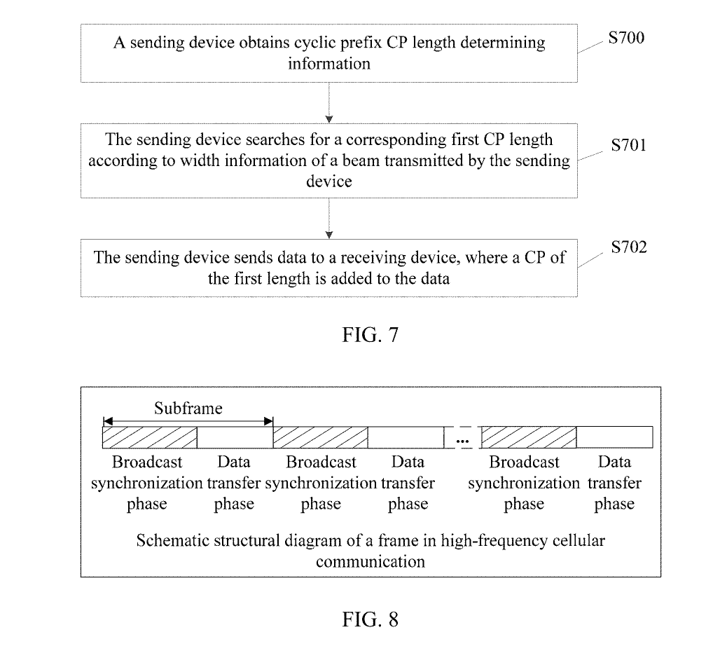

Referring to FIG. 7, FIG. 7 is a schematic flowchart of another embodiment of a data sending method according to the embodiments of the present invention. In this embodiment of the present invention, the following describes in detail a case in which CP length determining information includes width information of a beam transmitted by a sending device.

It should be noted that, for the CP length determining information in this embodiment, a new implementation may be formed by combining at least one implementation of the embodiment in FIG. 4 and this embodiment. That is, the CP length determining information may include the width information of the beam and data stream quantity information of to-be-sent data. The sending device may search, according to implementations of the embodiment in FIG. 4 and this embodiment, for a CP length corresponding to each piece of information in the CP length determining information, and then determine a first CP length according to the found CP length corresponding to each piece of information. Optionally, the sending device may select a largest value from the CP lengths corresponding to all the pieces of information, as the first CP length. For example, if the sending device obtains the data stream quantity information of the data and the width information of the beam, after obtaining CP lengths corresponding to the data stream quantity information of the data and the width information of the beam, the sending device compares the CP length corresponding to the data stream quantity information of the data with the CP length corresponding to the width information of the beam. If the CP length corresponding to the data stream quantity information of the data is greater than the CP length corresponding to the width information of the beam, the CP length corresponding to the data stream quantity information of the data is used as the first CP length.

As shown in FIG. 7, the another embodiment of the data sending method according to the embodiments of the present invention may include the following steps.

S700: The sending device obtains the cyclic prefix CP length determining information.

In specific implementation, the CP length determining information may include the width information of the beam transmitted by the sending device. As shown in FIG. 8, for example, a sending device is a base station and a receiving device is a mobile terminal. A high-frequency cellular communication phase is divided into a broadcast synchronization phase and a data transfer phase. In the broadcast synchronization phase, the base station and the mobile terminal are synchronized, and the base station sends system information to the mobile terminal, so that the mobile terminal accesses the base station. Therefore, the base station transmits a wide beam. In the data transfer phase of the base station and the mobile terminal, the base station transmits a narrow beam to ensure accuracy of data received by the mobile terminal. Because a wider beam indicates a larger CP length, it can be learned that a CP length is related to a beam width. Therefore, the CP length determining information may include the width information of the beam transmitted by the sending device, and a correspondence between width information of a beam transmitted by the sending device and a CP length may be preset. The sending device may obtain a required CP length according to width information of a transmitted beam and a correspondingly generated multipath delay, to establish a correspondence between the width information of the beam and the CP length.

S701: The sending device searches for the corresponding first CP length according to the width information of the beam transmitted by the sending device.

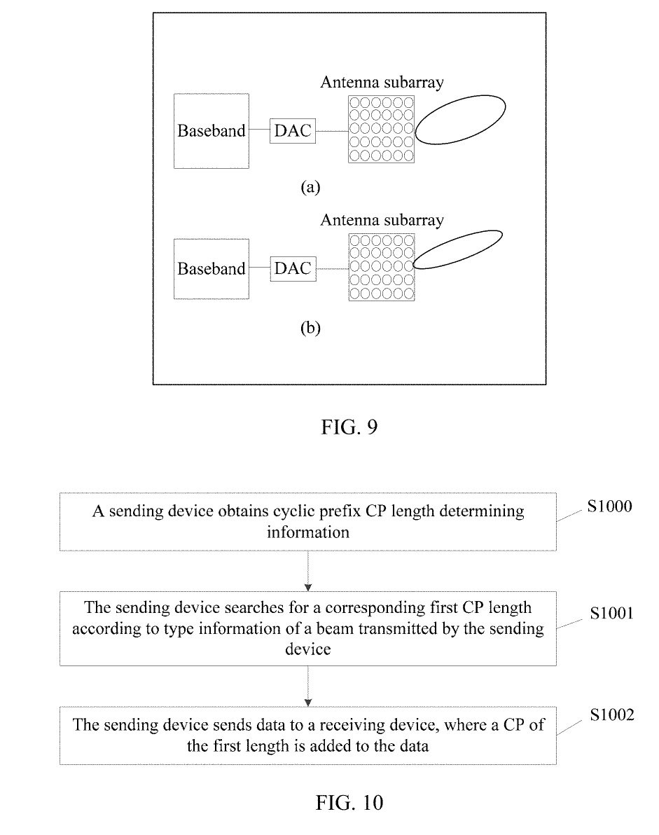

In specific implementation, because a wider beam indicates a larger CP length, a CP length of data sent by the base station in the broadcast synchronization phase is greater than a CP length of data sent by the base station in the data transfer phase. As shown in FIG. 9, a width of a beam transmitted by a sending device in FIG. 9(a) is greater than a width of a beam transmitted by a sending device in FIG. 9(b). It can be learned that FIG. 9(a) shows a broadcast synchronization phase, and FIG. 9(b) shows a data transfer phase. The base station may search for a first CP length according to a correspondence between width information of a transmitted beam and a CP length.

S702: The sending device sends data to a receiving device, where a CP of the first length is added to the data.

In specific implementation, after finding the first CP length according to the width information of the transmitted beam, the sending device may add the CP of the first length to a beginning of the data, so as to resist a multipath effect and reduce system overheads during a data transmission process.

According to this embodiment of the present invention, the sending device obtains the cyclic prefix CP length determining information, where the CP length determining information includes the width information of the beam transmitted by the sending device. The sending device determines the first CP length according to the width information of the transmitted beam. The sending device sends the data to the receiving device, where the CP of the first length is added to the data. The sending device may dynamically determine a CP length according to CP length determining information each time before sending data. This can reduce system overheads, protect system performance, and ensure that the sending device and the receiving device communicate normally.

Referring to FIG. 10, FIG. 10 is a schematic flowchart of another embodiment of a data sending method according to the embodiments of the present invention. In this embodiment of the present invention, the following describes in detail a case in which CP length determining information includes type information of a beam transmitted by a sending device.

It should be noted that, for the CP length determining information in this embodiment, a new implementation may be formed by combining at least one implementation of the embodiment in FIG. 4, the embodiment in FIG. 7, and this embodiment. That is, the CP length determining information may include at least two of data stream quantity information of to-be-sent data, width information of the beam, or the type information of the beam. The sending device may search, according to implementations of the embodiment in FIG. 4, the embodiment in FIG. 7, and this embodiment, for a CP length corresponding to each piece of information in the CP length determining information, and then determine a first CP length according to the found CP length corresponding to each piece of information. Optionally, the sending device may select a largest value from the CP lengths corresponding to all the pieces of information, as the first CP length. Details are not described in this embodiment.

As shown in FIG. 10, the another embodiment of the data sending method according to the embodiments of the present invention may include the following steps.

S1000: The sending device obtains the cyclic prefix CP length determining information.

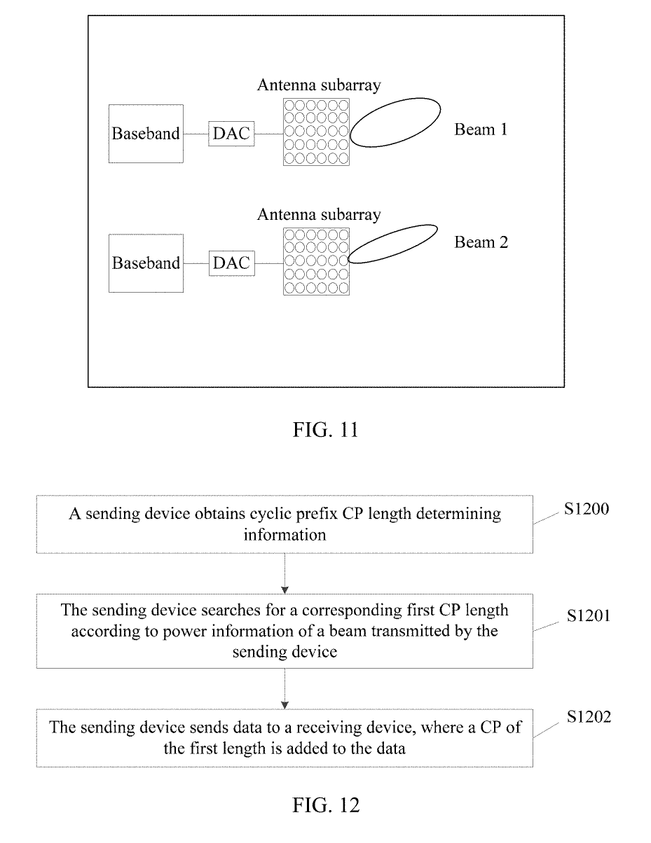

In specific implementation, the CP length determining information may include the type information of the beam transmitted by the sending device. As shown in FIG. 11, FIG. 11 includes a beam 1 and a beam 2. Different beam types (for example, IDs (identity)) require different CP lengths. Therefore, the CP length determining information may include the type information of the beam transmitted by the sending device, and a correspondence between type information of a beam transmitted by the sending device and a CP length may be preset. The sending device may obtain a required CP length according to type information of a transmitted beam and a correspondingly generated multipath delay, to establish a correspondence between the type information of the beam and the CP length.

S1001: The sending device searches for a corresponding first CP length according to the type information of the beam transmitted by the sending device.

In specific implementation, the sending device may search for the first CP length according to according to the correspondence between the type information of the transmitted beam and a CP length and/or a correspondence between width information of the beam and a CP length.

In an implementation, in addition to searching for the first CP length according to the type information of the transmitted beam, the sending device may alternatively search for the first CP length according to a quantity of types of transmitted beams that is supported by the sending device and a quantity of CP length types that is supported by the sending device. As shown in Table 2 below, P represents the quantity of types of transmitted beams that is supported by the sending device, and Q represents the quantity of CP length types that is supported by the sending device. For example, if the quantity of types of transmitted beams that is supported by the sending device is 4, and the supported quantity of CP length types is 3 (that is, a corresponding matching mode is a matching mode 2, P=4, and Q=3), when a beam transmitted by the sending device is a beam 2 (that is, an ID of the beam is 2), a first CP length found is a length identified by CP2 in Table 2.

TABLE 2

| Matching mode 1 | | Matching mode 2 | | Matching mode 3 | |
|---|---|---|---|---|---|
| (P = 4, Q = 5) | | (P = 4, Q = 3) | | (P = 4, Q = 4) | |
| Beam ID | CP length | Beam ID | CP length | Beam ID | CP length |
| 1 | CP1 | 1 | CP1 | 1 | CP1 |
| 2 | CP2 | 2 | CP2 | 2 | CP2 |
| 3 | CP3 | 3 | CP2 | 3 | CP3 |
| 4 | CP5 | 4 | CP3 | 4 | CP4 |

S1002: The sending device sends data to a receiving device, where a CP of the first length is added to the data.

In specific implementation, after finding the first CP length according to the type information of the transmitted beam, the sending device may add the CP of the first length to a beginning of the data, so as to resist a multipath effect and reduce system overheads during a data transmission process.

According to this embodiment of the present invention, the sending device obtains the cyclic prefix CP length determining information, where the CP length determining information may include the type information of the beam transmitted by the sending device. The sending device searches for the corresponding first CP length according to the type information of the beam transmitted by the sending device. The sending device sends the data to the receiving device, where the CP of the first length is added to the data. The sending device may dynamically determine a CP length according to CP length determining information each time before sending data. This can reduce system overheads, protect system performance, and ensure that the sending device and the receiving device communicate normally.

Referring to FIG. 12, FIG. 12 is a schematic flowchart of another embodiment of a data sending method according to the embodiments of the present invention. In this embodiment of the present invention, the following describes in detail a case in which CP length determining information includes power information of a beam transmitted by a sending device.

It should be noted that, for the CP length determining information in this embodiment, a new implementation may be formed by combining at least one implementation of the embodiment in FIG. 4 to the embodiment in FIG. 10 and this embodiment. That is, the CP length determining information may include at least two of data stream quantity information of to-be-sent data, width information of the beam, type information of the beam, or the power information of the beam. The sending device may search, according to implementations of the embodiment in FIG. 4 to the embodiment in FIG. 10 and this embodiment, for a CP length corresponding to each piece of information in the CP length determining information, and then determine a first CP length according to the found CP length corresponding to each piece of information. Optionally, the sending device may select a largest value from the CP lengths corresponding to all the pieces of information, as the first CP length. Details are not described in this embodiment.

As shown in FIG. 12, the another embodiment of the data sending method according to the embodiments of the present invention may include the following steps.

S1200: The sending device obtains the cyclic prefix CP length determining information.

In specific implementation, the CP length determining information may include the power information of the beam transmitted by the sending device. The CP length is directly proportional to the power of the beam transmitted by the sending device. When the sending device transmits a high-power beam, a generated multipath delay is longer than a multipath delay that is generated when a low-power beam is transmitted. A CP length required when the sending device transmits the high-power beam is greater than a CP length required when the sending device transmits the low-power beam. Therefore, a correspondence between power information of a beam transmitted by the sending device and a CP length may be preset. The sending device may obtain a required CP length according to power information of a transmitted beam and a correspondingly generated multipath delay, to establish a correspondence between the power information of the beam and the CP length.

S1201: The sending device searches for a corresponding first CP length according to the power information of the beam transmitted by the sending device.

In specific implementation, the sending device may search for the first CP length based on the power information of the transmitted beam and the correspondence between power information of a beam and a CP length.

S1202: The sending device sends data to a receiving device, where a CP of the first length is added to the data.

In specific implementation, after finding the first CP length according to the power information of the transmitted beam, the sending device may add the CP of the first length to a beginning of the data, so as to resist a multipath effect and reduce system overheads during a data transmission process.

According to this embodiment of the present invention, the sending device obtains the cyclic prefix CP length determining information, where the CP length determining information may include the power information of the beam transmitted by the sending device. The sending device searches for the corresponding first CP length according to the power information of the beam transmitted by the sending device. The sending device sends the data to the receiving device, where the CP of the first length is added to the data. The sending device may dynamically determine a CP length according to CP length determining information each time before sending data. This can reduce system overheads, protect system performance, and ensure that the sending device and the receiving device communicate normally.

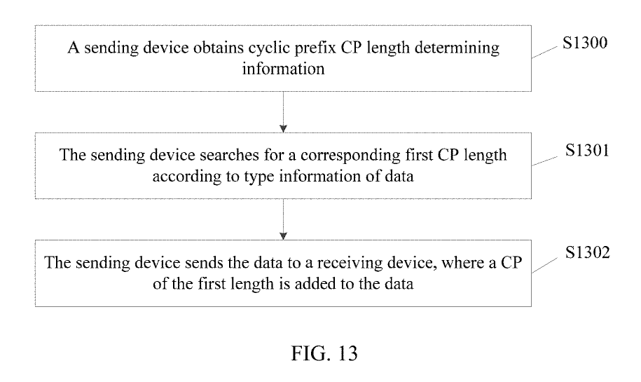

Referring to FIG. 13, FIG. 13 is a schematic flowchart of another embodiment of a data sending method according to the embodiments of the present invention. In this embodiment of the present invention, the following describes in detail a case in which CP length determining information includes type information of data.

It should be noted that, for the CP length determining information in this embodiment, a new implementation may be formed by combining at least one implementation of the embodiment in FIG. 4 to the embodiment in FIG. 12 and this embodiment. That is, the CP length determining information may include at least two of data stream quantity information of the to-be-sent data, width information of a beam, type information of the beam, power information of the beam, or the type information of the data. The sending device may search, according to implementations of the embodiment in FIG. 4 to the embodiment in FIG. 12 and this embodiment, for a CP length corresponding to each piece of information in the CP length determining information, and then determine a first CP length according to the found CP length corresponding to each piece of information. Optionally, the sending device may select a largest value from the CP lengths corresponding to all the pieces of information, as the first CP length. Details are not described in this embodiment.

As shown in FIG. 13, the another embodiment of the data sending method according to the embodiments of the present invention may include the following steps.

S1300: The sending device obtains the cyclic prefix CP length determining information.

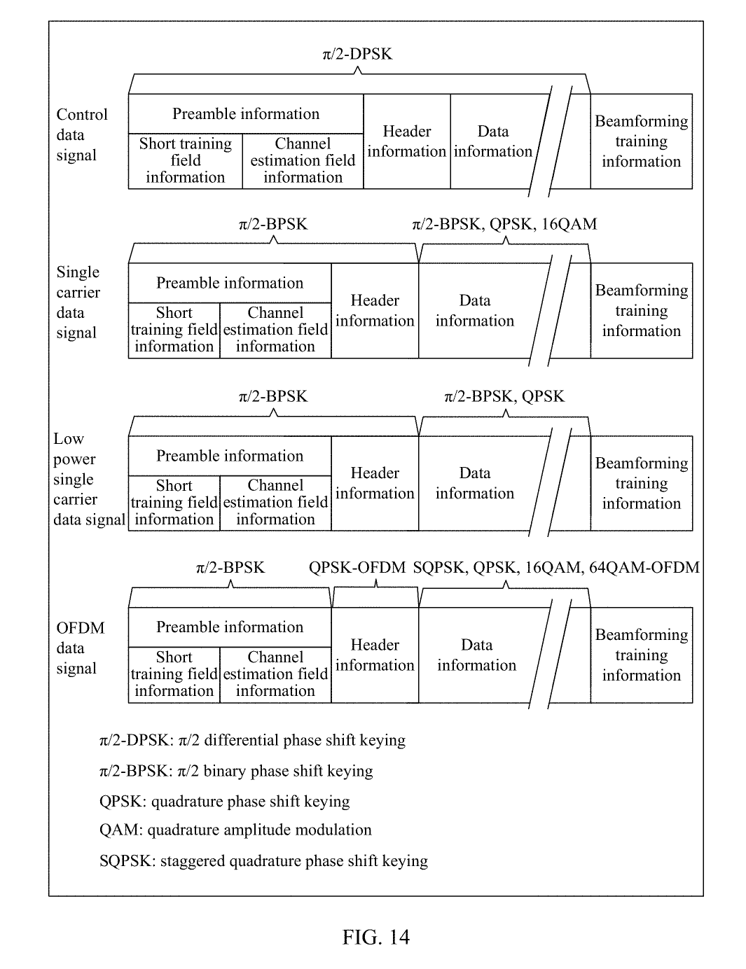

In specific implementation, the CP length determining information includes the type information of the data. For different types of data, CP lengths of the data are also different. As shown in FIG. 14, FIG. 14 is a schematic structural diagram of a data frame in a local area network communications system, where a data frame structure includes preamble (Preamble) information, short training field (STF, Short Training Field) information, channel estimation field (CEF, Channel Estimation Field) information, header (Header) information, data (Data) information, and beamforming training (Beamforming Training) information. Preamble information to data information of control (Control) data are modulated by using π/2-DPSK (π/2 Differential Phase Shift Keying, π/2 differential phase shift keying). In a single carrier system, preamble information to header information of single carrier (Single Carrier) data are modulated by using π/2-BPSK (π/2 Binary Phase Shift Keying, π/2 binary phase shift keying), and data information may be modulated by using any one of π/2-BPSK, QPSK (Quadrature Phase Shift Keying, quadrature phase shift keying), or 16QAM (16 Quadrature Amplitude Modulation, 16 quadrature amplitude modulation). Preamble information to header information of low power single carrier (Low Power Single Carrier) data are modulated by using π/2-BPSK, and data information may be modulated by using π/2-BPSK and/or QPSK. In a multicarrier OFDM system, preamble information to channel estimation field information of OFDM data are modulated by using π/2-BPSK, header information is modulated by using QPSK-OFDM, and data information may be modulated by using SQPSK (Staggered Quadrature Phase shift Keying, staggered quadrature phase shift keying), QPSK, 16QAM, or 64QAM-OFDM. Types of data in different systems are different, and different types of data require different CP lengths. The sending device may obtain a required CP length according to type information of data and a correspondingly generated multipath delay, to establish a correspondence between the type information of the data and the CP length.

S1301: The sending device searches for a corresponding first CP length according to the type information of the data.

In specific implementation, the control data is data used by the sending device to control a receiving device to access the sending device. To enable the receiving device to accurately demodulate the control data, reliability of the control data needs to be improved, and the sending device needs to send the control data by using a wide beam. Therefore, a longer CP is required. The single carrier data, the low power single carrier data, and the OFDM data are service data used for interaction between the receiving device and the sending device after the receiving device successfully accesses the sending device. Therefore, reliability of the service data is relatively low. The sending device may send the service data by using a narrow beam. Therefore, a CP length may be reduced. Therefore, a CP length of the service data is less than a CP length of the control data. Therefore, the sending device may search for the corresponding first CP length according to a correspondence between type information of data and a CP length.

S1302: The sending device sends the data to the receiving device, where a CP of the first length is added to the data.

In specific implementation, after finding the first CP length according to the type information of the data, the sending device may add the CP of the first length to a beginning of the data, so as to resist a multipath effect and reduce system overheads during a data transmission process.

According to this embodiment of the present invention, the sending device obtains the cyclic prefix CP length determining information, where the CP length determining information includes the type information of the data. The sending device searches for the corresponding first CP length according to the type information of the data. The sending device sends the data to the receiving device, where the CP of the first length is added to the data. The sending device may dynamically determine a CP length according to CP length determining information each time before sending data. This can reduce system overheads, protect system performance, and ensure that the sending device and the receiving device communicate normally.

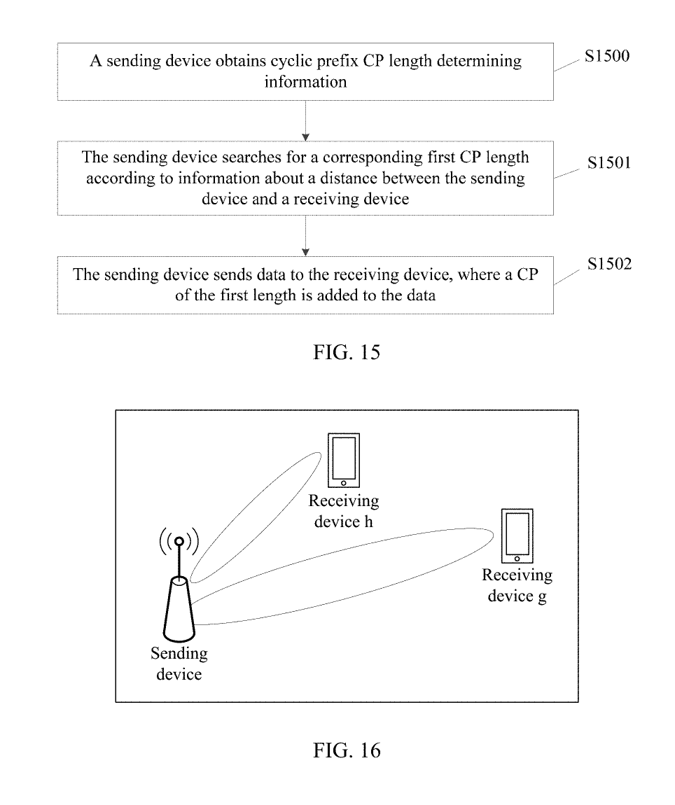

Referring to FIG. 15, FIG. 15 is a schematic flowchart of another embodiment of a data sending method according to the embodiments of the present invention. In this embodiment of the present invention, the following describes in detail a case in which CP length determining information includes information about a distance between a sending device and a receiving device.

It should be noted that, for the CP length determining information in this embodiment, a new implementation may be formed by combining at least one implementation of the embodiment in FIG. 4 to the embodiment in FIG. 13 and this embodiment. That is, the CP length determining information may include at least two of data stream quantity information of to-be-sent data, width information of a beam, type information of the beam, power information of the beam, type information of the data, or the information about the distance between the sending device and the receiving device. The sending device may search, according to implementations of the embodiment in FIG. 4 to the embodiment in FIG. 13 and this embodiment, for a CP length corresponding to each piece of information in the CP length determining information, and then determine a first CP length according to the found CP length corresponding to each piece of information. Optionally, the sending device may select a largest value from the CP lengths corresponding to all the pieces of information, as the first CP length. Details are not described in this embodiment.

As shown in FIG. 15, the another embodiment of the data sending method according to the embodiments of the present invention may include the following steps.

S1500: The sending device obtains the cyclic prefix CP length determining information.

In specific implementation, the CP length determining information includes the information about the distance between the sending device and the receiving device. The sending device may directly perform measurement or obtain, from the receiving device, location information of the receiving device, to determine the distance between the sending device and the receiving device. Therefore, the sending device may obtain a required CP length according to information about a distance between the sending device and the receiving device and a correspondingly generated multipath delay, to establish a correspondence between the information about the distance and the CP length.

S1501: The sending device searches for a corresponding first CP length according to the information about the distance between the sending device and the receiving device.

In specific implementation, a longer distance between the sending device and the receiving device indicates a longer multipath delay that is generated, and therefore indicates a larger CP length that is required. Therefore, the sending device may determine the first CP length according to the distance between the sending device and the receiving device. As shown in FIG. 16, a distance between a receiving device g and a sending device is longer than a distance between a receiving device h and the sending device. Therefore, a CP length of data sent by the sending device to the receiving device g is greater than a CP length of data sent by the sending device to the receiving device h. Therefore, the sending device may search for the corresponding first CP length according to a correspondence between information about a distance and a CP length.

S1502: The sending device sends data to the receiving device, where a CP of the first length is added to the data.

In specific implementation, after finding the first CP length according to the distance between the sending device and the receiving device, the sending device may add the CP of the first length to a beginning of the data, so as to resist a multipath effect and reduce system overheads during a data transmission process.

According to this embodiment of the present invention, the sending device obtains the cyclic prefix CP length determining information, where the CP length determining information includes the information about the distance between the sending device and the receiving device. The sending device searches for the corresponding first CP length according to the information about the distance between the sending device and the receiving device. The sending device sends the data to the receiving device, where the CP of the first length is added to the data. The sending device may dynamically determine a CP length according to CP length determining information each time before sending data. This can reduce system overheads, protect system performance, and ensure that the sending device and the receiving device communicate normally.

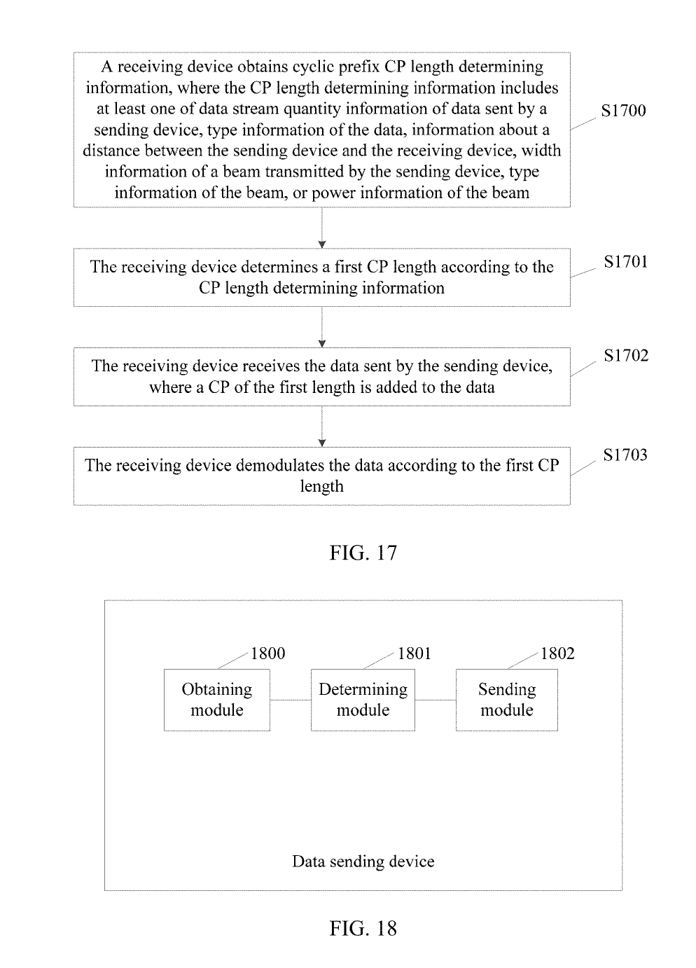

Referring to FIG. 17, FIG. 17 is a schematic flowchart of an embodiment of a data demodulation method according to the embodiments of the present invention.

It should be noted that CP length determining information in this embodiment may cover at least one implementation of the embodiment in FIG. 4 to the embodiment in FIG. 15. Details are not described in this embodiment.

As shown in FIG. 17, this embodiment of the data demodulation method according to the embodiments of the present invention may include the following steps.

S1700: A receiving device obtains the cyclic prefix CP length determining information, where the CP length determining information includes at least one of data stream quantity information of data sent by a sending device, type information of the data, information about a distance between the sending device and the receiving device, width information of a beam transmitted by the sending device, type information of the beam, or power information of the beam.

In specific implementation, the receiving device may receive the CP length determining information sent by the sending device, to learn a CP length of the data. If the receiving device receives the CP length determining information sent by the sending device, the CP length determining information may include at least one of the data stream quantity information of the sent data, the width information of the beam, the type information of the beam, the power information of the beam, the type information of the data, or the information about the distance between the sending device and the receiving device.

In an implementation, the CP length determining information may include a first CP length determined by the sending device.

S1701: The receiving device determines the first CP length according to the CP length determining information.

In specific implementation, the receiving device may determine the first CP length according to the CP length determining information sent by the sending device.

In an implementation, the receiving device may proactively detect a CP length of the data. That the receiving device proactively detects a CP length of the data belongs to the prior art, and details are not described in this embodiment of the present invention.

S1702: The receiving device receives the data sent by the sending device, where a CP of the first length is added to the data.

In specific implementation, after determining the first CP length, the sending device adds the CP of the first length to the data, and then sends, to the receiving device, the data to which the CP of the first length is added.

S1703: The receiving device demodulates the data according to the first CP length.

In specific implementation, after receiving the data, the receiving device demodulates the data according to the first CP length determined by the receiving device.

According to this embodiment of the present invention, the receiving device obtains the cyclic prefix CP length determining information, where the CP length determining information includes at least one of the data stream quantity information of the data sent by the sending device, the type information of the data, the information about the distance between the sending device and the receiving device, the width information of the beam transmitted by the sending device, the type information of the beam, or the power information of the beam. The receiving device determines the first CP length according to the CP length determining information. The receiving device receives the data sent by the sending device, where the CP of the first length is added to the data. The receiving device demodulates the data according to the first CP length. The receiving device may determine the first CP length according to the CP length determining information, and then demodulate the data according to the first CP length. This can reduce a time of interaction between the receiving device and the sending device before the receiving device demodulates the data, reduce system overheads, protect system performance, and ensure that the sending device and the receiving device communicate normally.

Referring to FIG. 18, FIG. 18 is a schematic structural diagram of an embodiment of a data sending device according to the embodiments of the present invention. For steps related to this embodiment, refer to at least one of the embodiments in FIG. 3 to FIG. 15. Details are not described in this embodiment again. The device shown in FIG. 18 includes an obtaining module 1800, a determining module 1801, and a sending module 1802.

The obtaining module 1800 is configured to obtain cyclic prefix CP length determining information, where the CP length determining information includes at least one of data stream quantity information of data to be sent by the device, type information of the data, information about a distance between the device and a receiving device, width information of a beam transmitted by the device, type information of the beam, or power information of the beam.

The determining module 1801 is configured to determine a first CP length according to the CP length determining information obtained by the obtaining module 1800.

The sending module 1802 is configured to send the data to the receiving device, where a CP of the first length determined by the determining module 1801 is added to the data.

In specific implementation, the sending device may obtain CP length determining information each time before sending data, to calculate a first CP length according to the determining information. The CP length determining information includes at least one of the data stream quantity information of the data to be sent by the sending device, the width information of the beam, the type information of the beam, the power information of the beam, the type information of the data, or the information about the distance between the sending device and the receiving device. The sending device can extract, from the sending device itself, the the data stream quantity information of the data, the width information of the beam, the type information of the beam, the power information of the beam, and the type information of the data. Therefore, the sending device does not need to obtain the foregoing information from another device (for example, the receiving device). The sending device may directly perform measurement or obtain, from the receiving device, location information of the receiving device, to determine the information about the distance between the sending device and the receiving device.

In specific implementation, the sending device may preset a correspondence between CP length determining information and a CP length, and then search for the first CP length according to the foregoing obtained CP length determining information, to generate a CP according to the determined first length.

In specific implementation, the sending device may add the CP of the first length to a beginning of the data, so as to resist a multipath effect and reduce system overheads during a data transmission process.

In an implementation, the CP length determining information includes any one of the data stream quantity information of the data to be sent by the device, the type information of the data, the information about the distance between the device and the receiving device, the width information of the beam transmitted by the device, the type information of the beam, or the power information of the beam, and the determining module 1801 is specifically configured to:

search for the corresponding first CP length according to the any one of the data stream quantity information of the data to be sent by the device, the type information of the data, the information about the distance between the device and the receiving device, the width information of the beam transmitted by the device, the type information of the beam, or the power information of the beam.

In an implementation, if the CP length determining information includes at least two of the data stream quantity information of the data to be sent by the device, the type information of the data, the information about the distance between the device and the receiving device, the width information of the beam transmitted by the device, the type information of the beam, or the power information of the beam, the determining module 1801 is specifically configured to:

search for a corresponding CP length according to the at least two of the data stream quantity information of the data to be sent by the device, the type information of the data, the information about the distance between the device and the receiving device, the width information of the beam transmitted by the device, the type information of the beam, or the power information of the beam; and

determine the first CP length according to the corresponding CP length that is found.

According to this embodiment of the present invention, the sending device obtains the cyclic prefix CP length determining information, where the CP length determining information includes at least one of the data stream quantity information of the data to be sent by the sending device, the type information of the data, the information about the distance between the sending device and the receiving device, the width information of the beam transmitted by the sending device, the type information of the beam, or the power information of the beam. The sending device determines the first CP length according to the CP length determining information. The sending device sends the data to the receiving device, where the CP of the first length is added to the data. The sending device may dynamically determine a CP length according to CP length determining information each time before sending data. This can reduce system overheads, protect system performance, and ensure that the sending device and the receiving device communicate normally.

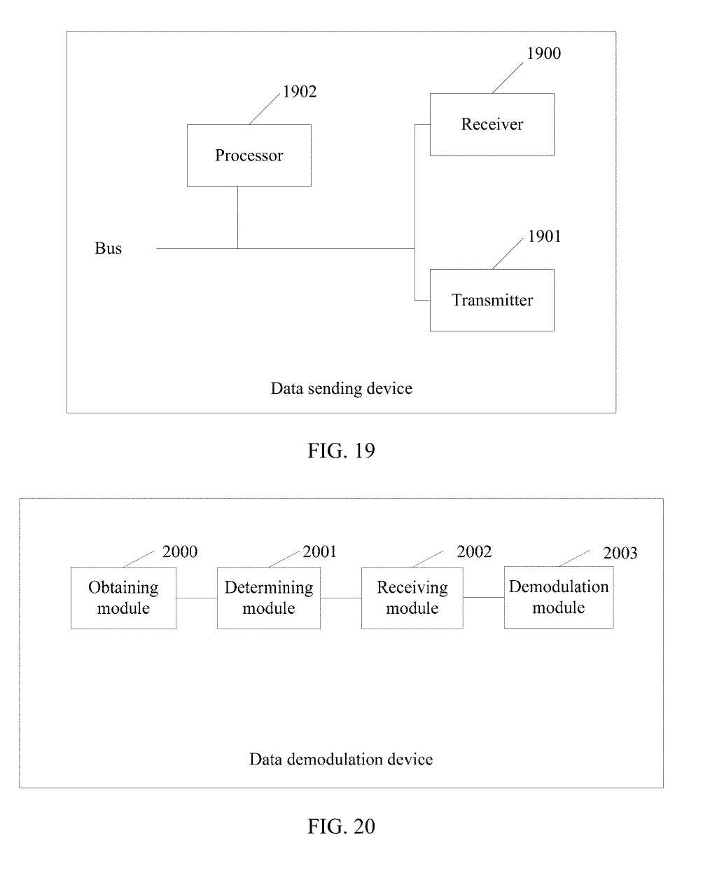

Referring to FIG. 19, FIG. 19 is a schematic structural diagram of another embodiment of a data sending device according to the embodiments of the present invention. For steps related to this embodiment, refer to at least one of the embodiments in FIG. 3 to FIG. 15. Details are not described in this embodiment again. The device shown in FIG. 19 includes a receiver 1900, a transmitter 1901, and a processor 1902 (the device may have one or more processors 1902, and one processor is used as an example in FIG. 19). In this embodiment of the present invention, the receiver 1900, the transmitter 1901, and the processor 1902 may be connected by using a bus or in another manner. In FIG. 19, for example, connection is implemented by using a bus.

The receiver 1900 is configured to obtain cyclic prefix CP length determining information, where the CP length determining information includes at least one of data stream quantity information of data to be sent by the device, type information of the data, information about a distance between the device and a receiving device, width information of a beam transmitted by the device, type information of the beam, or power information of the beam.

The processor 1902 is configured to determine a first CP length according to the CP length determining information.

The transmitter 1901 is configured to send the data to the receiving device, where a CP of the first length is added to the data.

In specific implementation, the sending device may obtain CP length determining information each time before sending data, to calculate a first CP length according to the determining information. The CP length determining information includes at least one of the data stream quantity information of the data to be sent by the sending device, the width information of the beam, the type information of the beam, the power information of the beam, the type information of the data, or the information about the distance between the sending device and the receiving device. The sending device can extract, from the sending device itself, the the data stream quantity information of the data, the width information of the beam, the type information of the beam, the power information of the beam, and the type information of the data. Therefore, the sending device does not need to obtain the foregoing information from another device (for example, the receiving device). The sending device may directly perform measurement or obtain, from the receiving device, location information of the receiving device, to determine the information about the distance between the sending device and the receiving device.

In specific implementation, the sending device may preset a correspondence between CP length determining information and a CP length, and then search for the first CP length according to the foregoing obtained CP length determining information, to generate a CP according to the determined first length.

In specific implementation, the sending device may add the CP of the first length to a beginning of the data, so as to resist a multipath effect and reduce system overheads during a data transmission process.

In an implementation, if the CP length determining information includes any one of the data stream quantity information of the data to be sent by the device, the type information of the data, the information about the distance between the device and the receiving device, the width information of the beam transmitted by the device, the type information of the beam, or the power information of the beam, the processor 1902 is specifically configured to perform the following step when determining the first CP length according to the CP length determining information:

searching for the corresponding first CP length according to the any one of the data stream quantity information of the data to be sent by the device, the type information of the data, the information about the distance between the device and the receiving device, the width information of the beam transmitted by the device, the type information of the beam, or the power information of the beam.

In an implementation, if the CP length determining information includes at least two of the data stream quantity information of the data to be sent by the device, the type information of the data, the information about the distance between the device and the receiving device, the width information of the beam transmitted by the device, the type information of the beam, or the power information of the beam, the processor 1902 is specifically configured to perform the following steps when determining the first CP length according to the CP length determining information:

searching for a corresponding CP length according to the at least two of the data stream quantity information of the data to be sent by the device, the type information of the data, the information about the distance between the device and the receiving device, the width information of the beam transmitted by the device, the type information of the beam, or the power information of the beam; and

determining the first CP length according to the corresponding CP length that is found.

According to this embodiment of the present invention, the sending device obtains the cyclic prefix CP length determining information, where the CP length determining information includes at least one of the data stream quantity information of the data to be sent by the sending device, the type information of the data, the information about the distance between the sending device and the receiving device, the width information of the beam transmitted by the sending device, the type information of the beam, or the power information of the beam. The sending device determines the first CP length according to the CP length determining information. The sending device sends the data to the receiving device, where the CP of the first length is added to the data. The sending device may dynamically determine a CP length according to CP length determining information each time before sending data. This can reduce system overheads, protect system performance, and ensure that the sending device and the receiving device communicate normally.

Referring to FIG. 20, FIG. 20 is a schematic structural diagram of an embodiment of a data demodulation device according to the embodiments of the present invention. For steps related to this embodiment, refer to at least one of the embodiments in FIG. 3 to FIG. 15. Details are not described in this embodiment again. The device shown in FIG. 20 includes an obtaining module 2000, a determining module 2001, a receiving module 2002, and a demodulation module 2003.

The obtaining module 2000 is configured to obtain cyclic prefix CP length determining information, where the CP length determining information includes at least one of data stream quantity information of data sent by a sending device, type information of the data, information about a distance between the sending device and the device, width information of a beam transmitted by the sending device, type information of the beam, or power information of the beam.

The determining module 2001 is configured to determine a first CP length according to the CP length determining information obtained by the obtaining module 2000.

The receiving module 2002 is configured to receive the data sent by the sending device, where a CP of the first length determined by the determining module 2001 is added to the data.

The demodulation module 2003 is configured to demodulate the data according to the first CP length.

In specific implementation, the receiving device may receive the CP length determining information sent by the sending device, to learn a CP length of the data. If the receiving device receives the CP length determining information sent by the sending device, the CP length determining information may include at least one of the data stream quantity information of the sent data, the width information of the beam, the type information of the beam, the power information of the beam, the type information of the data, or the information about the distance between the sending device and the receiving device.

In specific implementation, the receiving device may determine the first CP length according to the CP length determining information sent by the sending device.

In specific implementation, after determining the first CP length, the sending device adds the CP of the first length to the data, and then sends, to the receiving device, the data to which the CP of the first length is added.

In specific implementation, after receiving the data, the receiving device demodulates the data according to the first CP length determined by the receiving device.

According to this embodiment of the present invention, the receiving device obtains the cyclic prefix CP length determining information, where the CP length determining information includes at least one of the data stream quantity information of the data sent by the sending device, the type information of the data, the information about the distance between the sending device and the device, the width information of the beam transmitted by the sending device, the type information of the beam, or the power information of the beam. The receiving device determines the first CP length according to the CP length determining information. The receiving device receives the data sent by the sending device, where the CP of the first length is added to the data. The receiving device demodulates the data according to the first CP length. The receiving device may determine the first CP length according to the CP length determining information, and then demodulate the data according to the first CP length. This can reduce a time of interaction between the receiving device and the sending device before the receiving device demodulates the data, reduce system overheads, protect system performance, and ensure that the sending device and the receiving device communicate normally.

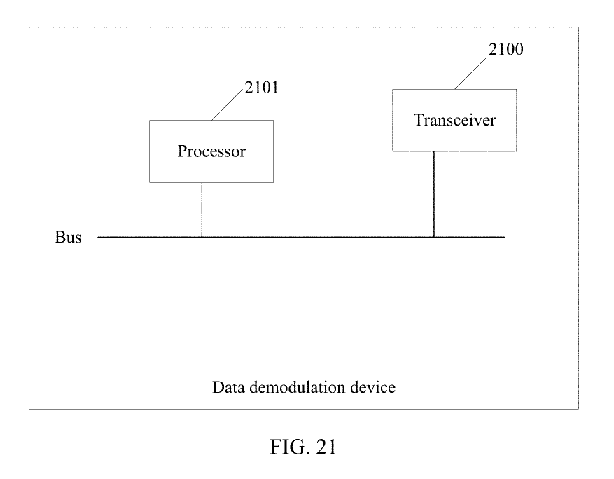

Referring to FIG. 21, FIG. 21 is a schematic structural diagram of another embodiment of a data demodulation device according to the embodiments of the present invention. For steps related to this embodiment, refer to at least one of the embodiments in FIG. 3 to FIG. 17. Details are not described in this embodiment again. The device shown in FIG. 21 includes a transceiver 2100 and a processor 2101 (the device may have one or more processors 2101, and one processor is used as an example in FIG. 21). In this embodiment of the present invention, the transceiver 2100 and the processor 2101 may be connected by using a bus or in another manner. In FIG. 21, for example, connection is implemented by using a bus.

The transceiver 2100 is configured to obtain cyclic prefix CP length determining information, where the CP length determining information includes at least one of data stream quantity information of data sent by a sending device, type information of the data, information about a distance between the sending device and the device, width information of a beam transmitted by the sending device, type information of the beam, or power information of the beam.

The processor 2101 is configured to determine a first CP length according to the CP length determining information.

The transceiver 2100 is further configured to receive the data sent by the sending device, where a CP of the first length is added to the data.

The processor 2101 is further configured to demodulate the data according to the first CP length.

In specific implementation, the receiving device may receive the CP length determining information sent by the sending device, to learn a CP length of the data. If the receiving device receives the CP length determining information sent by the sending device, the CP length determining information may include at least one of the data stream quantity information of the sent data, the width information of the beam, the type information of the beam, the power information of the beam, the type information of the data, or the information about the distance between the sending device and the receiving device.

In specific implementation, the receiving device may determine the first CP length according to the CP length determining information sent by the sending device.

In specific implementation, after determining the first CP length, the sending device adds the CP of the first length to the data, and then sends, to the receiving device, the data to which the CP of the first length is added.

In specific implementation, after receiving the data, the receiving device demodulates the data according to the first CP length determined by the receiving device.

According to this embodiment of the present invention, the receiving device obtains the cyclic prefix CP length determining information, where the CP length determining information includes at least one of the data stream quantity information of the data sent by the sending device, the type information of the data, the information about the distance between the sending device and the device, the width information of the beam transmitted by the sending device, the type information of the beam, or the power information of the beam. The receiving device determines the first CP length according to the CP length determining information. The receiving device receives the data sent by the sending device, where the CP of the first length is added to the data. The receiving device demodulates the data according to the first CP length. The receiving device may determine the first CP length according to the CP length determining information, and then demodulate the data according to the first CP length. This can reduce a time of interaction between the receiving device and the sending device before the receiving device demodulates the data, reduce system overheads, protect system performance, and ensure that the sending device and the receiving device communicate normally.

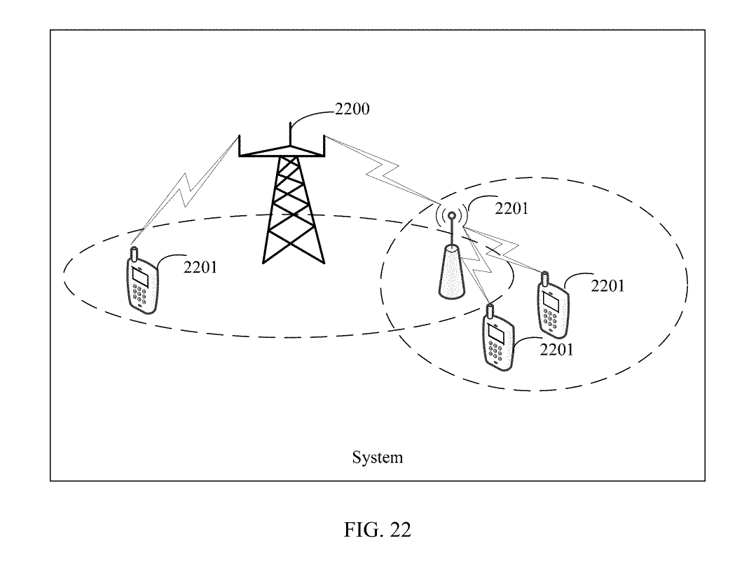

Referring to FIG. 22, FIG. 22 is a schematic structural diagram of an embodiment of a system according to the embodiments of the present invention. The system shown in the figure may be a high-frequency cellular communications system, and includes a sending device 2200 and a receiving device 2201 that are described in the embodiments in FIG. 3 to FIG. 21. The sending device 2200 may be a base station, and the receiving device 2201 may be a relay node (Relay Node) or a mobile terminal.

The sending device 2200 is configured to: obtain cyclic prefix CP length determining information, where the CP length determining information includes at least one of data stream quantity information of data to be sent by the sending device, type information of the data, information about a distance between the sending device and the receiving device, width information of a beam transmitted by the sending device, type information of the beam, or power information of the beam; determine a first CP length according to the CP length determining information; and send the data to the receiving device 2201, where a CP of the first length is added to the data.

The receiving device 2201 is configured to: obtain the CP length determining information; determine the first CP length according to the CP length determining information; receive the data sent by the sending device 2200, where the CP of the first length is added to the data; and demodulate the data according to the first CP length.

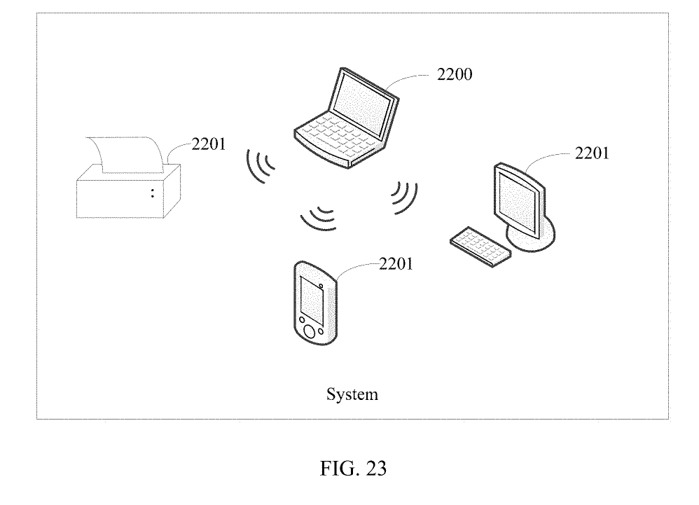

In an implementation, the system in this embodiment of the present invention may alternatively be a local area network communications system shown in FIG. 23 and communicate by using WiFi. The sending device 2200 may be a terminal device, for example, a computer device, in the system. The receiving device 2201 may be another terminal device, for example, another computer device, a mobile device, or a printer device.

According to this embodiment of the present invention, the sending device obtains the cyclic prefix CP length determining information, where the CP length determining information includes at least one of the data stream quantity information of the data to be sent by the sending device, the type information of the data, the information about the distance between the sending device and the receiving device, the width information of the beam transmitted by the sending device, the type information of the beam, or the power information of the beam. The sending device determines the first CP length according to the CP length determining information, and sends the data to the receiving device, where the CP of the first length is added to the data. The receiving device obtains the CP length determining information; determines the first CP length according to the CP length determining information; receives the data sent by the sending device, where the CP of the first length is added to the data; and demodulates the data according to the first CP length. The sending device may dynamically determine a CP length according to CP length determining information each time before sending data. This can reduce system overheads, protect system performance, and ensure that the sending device and the receiving device communicate normally.

With descriptions of the foregoing implementations, a person skilled in the art can clearly understand that the present invention may be implemented by using hardware, firmware, or a combination thereof. When the present invention is implemented by using software, the foregoing functions may be stored in a computer readable medium or be sent as one or more instructions or code in a computer readable medium. The computer readable medium includes a computer storage medium and a communications medium, where the communications medium includes any medium that facilitates transmission of a computer program from one place to another. The storage medium may be any available medium accessible to a computer. The following provides an example but does not impose a limitation: The computer readable medium may include a RAM, a ROM, an EEPROM, a CD-ROM or another optical disc storage, a magnetic disk storage medium or another magnetic storage device, or any other medium that can be configured to carry or store expected program code in a form of an instruction or a data structure and that can be accessed by a computer. In addition, any connection may be appropriately defined as a computer readable medium. For example, if software is transmitted from a website, a server, or another remote source by using a coaxial cable, an optical fiber cable, a twisted pair, a digital subscriber line (DSL), or a wireless technology such as infrared, radio, or a microwave, the coaxial cable, the optical fiber cable, the twisted pair, the DSL, or the wireless technology such as infrared, radio, or a microwave is included in fixation of a medium to which they belong. For example, a disk (Disk) and a disc (disc) used in the present invention include a compact disc (CD), a laser disc, an optical disc, a digital versatile disc (DVD), a floppy disk, and a Blu-ray disc, where the disk generally duplicates data magnetically, and the disc duplicates data optically by using laser. The foregoing combination should also be included in the protection scope of the computer readable medium.

The content disclosed above is merely examples of embodiments of the present invention, and definitely cannot be used to limit the scope of the claims of the present invention. Therefore, equivalent changes made according to the claims of the present invention still fall within the scope of the present invention.

What is claimed is:

1. A data sending method, comprising:
obtaining, by a sending device, cyclic prefix (CP) length determining information, wherein the CP length determining information comprises at least one of data stream quantity information of data to be sent by the sending device, type information of the data, information about a distance between the sending device and a receiving device, width information of a beam transmitted by the sending device, type information of the beam, or power information of the beam;
determining, by the sending device, a first CP length according to the CP length determining information; and
sending, by the sending device, the data to the receiving device, wherein a CP of the first length is added to the data.

2. The method according to claim 1, wherein if the CP length determining information comprises any one of the data stream quantity information of the data to be sent by the sending device, the type information of the data, the information about the distance between the sending device and the receiving device, the width information of the beam transmitted by the sending device, the type information of the beam, or the power information of the beam, the determining, by the sending device, a first CP length according to the CP length determining information comprises:
searching, by the sending device, for the corresponding first CP length according to the any one of the data stream quantity information of the data to be sent by the sending device, the type information of the data, the information about the distance between the sending device and the receiving device, the width information of the beam transmitted by the sending device, the type information of the beam, or the power information of the beam.

3. The method according to claim 1, wherein if the CP length determining information comprises at least two of the data stream quantity information of the data to be sent by the sending device, the type information of the data, the information about the distance between the sending device and the receiving device, the width information of the beam transmitted by the sending device, the type information of the beam, or the power information of the beam, the determining, by the sending device, a first CP length according to the CP length determining information comprises:
searching, by the sending device, for a corresponding CP length according to the at least two of the data stream quantity information of the data to be sent by the sending device, the type information of the data, the information about the distance between the sending device and the receiving device, the width information of the beam transmitted by the sending device, the type information of the beam, or the power information of the beam; and
determining, by the sending device, the first CP length according to the corresponding CP length that is found.

4. A data demodulation method, comprising:
obtaining, by a receiving device, cyclic prefix (CP) length determining information, wherein the CP length determining information comprises at least one of data stream quantity information of data sent by a sending device, type information of the data, information about a distance between the sending device and the receiving device, width information of a beam transmitted by the sending device, type information of the beam, or power information of the beam;
determining, by the receiving device, a first CP length according to the CP length determining information;
receiving, by the receiving device, the data sent by the sending device, wherein a CP of the first length is added to the data; and
demodulating, by the receiving device, the data according to the first CP length.

5. A data sending device, comprising:
a receiver, configured to obtain cyclic prefix (CP) length determining information, wherein the CP length determining information comprises at least one of data stream quantity information of data to be sent by the device, type information of the data, information about a distance between the device and a receiving device, width information of a beam transmitted by the device, type information of the beam, or power information of the beam;
a processor, configured to determine a first CP length according to the CP length determining information obtained by the receiver; and
a transmitter, configured to send the data to the receiving device, wherein a CP of the first length determined by the processor is added to the data.

6. The device according to claim 5, wherein if the CP length determining information comprises any one of the data stream quantity information of the data to be sent by the device, the type information of the data, the information about the distance between the device and the receiving device, the width information of the beam transmitted by the device, the type information of the beam, or the power information of the beam, the processor is specifically configured to:
search for the corresponding first CP length according to the any one of the data stream quantity information of the data to be sent by the device, the type information of the data, the information about the distance between the device and the receiving device, the width information of the beam transmitted by the device, the type information of the beam, or the power information of the beam.

7. The device according to claim 5, wherein if the CP length determining information comprises at least two of the data stream quantity information of the data to be sent by the device, the type information of the data, the information about the distance between the device and the receiving device, the width information of the beam transmitted by the device, the type information of the beam, or the power information of the beam, the processor is specifically configured to:
search for a corresponding CP length according to the at least two of the data stream quantity information of the data to be sent by the device, the type information of the data, the information about the distance between the device and the receiving device, the width information of the beam transmitted by the device, the type information of the beam, or the power information of the beam; and
determine the first CP length according to the corresponding CP length that is found.
